(19) United States
(12) Patent Application Publication
(10) Pub. No.: US 2003/0023490 A1
(43) Pub. Date: Jan. 30, 2003

(54) Method, system and process to promote the sale of custom indication/imprint services through a pay for performance affiliate marketing system

(76) Inventors: Yolanda Renee Lenyon, Fairfax Station, VA (US); Michael Shelby Lenyon, Fairfax Station, VA (US)

Correspondence Address: Yolanda Renee Lenyon, 11903 Yates Ford Rd, Fairfax Station, VA, 22039, US

(21) Appl. No.: 10/201,486

(22) Filed: Jul. 24, 2002

Related U.S. Application Data
(60) Provisional application No. 60/307,617, filed on Jul. 26, 2001.

(51) Int. Cl. G06F 17/60

(52) U.S. Cl. 705/14; 358/3.29

(57) ABSTRACT

A system that is a central controller for the delivery of content for the purpose of promoting custom imprint/indication services. The system will deliver content on a predetermined, periodic time map to a plurality of users on a multi-tier basis through messaging and other networked delivery means. These users will receive said content via their respective information delivery systems and in turn display said content via their own networked information display platform(s) through multiple paths, all related to the ultimate goal of selling custom imprint/indication services.

### FIELD OF THE INVENTION

I wish to claim priority for Provisional Patent Application No.: 60/307,617. The present invention relates generally to the field of promotion, marketing and advertising of custom imprint services. More specifically, this invention relates to a method and system of promotional advertising wherein an custom imprinter, wishing to promote its goods or services, uses a central controller to deliver content through one or more tiers of intermediaries who invite their readers to imprint said content onto an article of manufacture in a design and color of their choosing. In return, intermediaries receive money on a pay-for-performance basis.

### TERMS OF THE INVENTION

Information Delivery Vehicle—means and system for delivering content to viewers Information Delivery Vehicle operator—the person administering the content delivery system imprinting device—Method of indication, etching, stenciling, and or engraving communication network—system on which the information delivery vehicle runs. Includes but is not limited to computers, the internet, satellite, broadband, cellular, cable transmission content—text indications, both digital and physical

### BACKGROUND OF THE INVENTION

In the fields of custom imprint marketing and advertising, the ultimate goal of most imprinters is to cost-effectively increase sales of their goods and services. Therefore, a particular advertisement or advertising campaign is deemed successful if it results in an increase in sales and revenue, net of advertising costs. A particular challenge for custom imprinters is to cost-effectively increase the distribution of their services through repeatable, scalable, and replicable promotion. In this vein, custom imprinters are increasing using the Internet to try to increase the distribution of their services. They work to generate traffic to their online stores by means such as trying to get inbound links to their websites from directories, search engines, and complimentary sites.

Content and service providers such as webmasters and mailing list hosts need effective, low maintenance ways to build and monetize viewers and users of their content and services. For example, some companies such as Yahoo Corporation offer free services and content, such as news and stock quotes, but display advertising messages to consumers to help offset the cost of their service. However, such ads have become increasingly ineffective as far as reader response. Thus, paying advertisers have become more and more scarce. A key problem has remained as to how to create economic value from website/messaging viewers and how to effectively integrate ads with the content and services potential consumers use and like.

Imprinter/engravers and online content providers have implemented various schemes to display their advertisements to targeted groups of consumers. Giftofwisdom.com, for instance, is the result of a agreement between the content providers at Quoteland.com and an imprinter/engraver to market the customer imprinting and engraving services by displaying wise, motivational, and inspirational quotations. The builders of quoteland.com promotes the giftofwisdom.com website (which is owned by quoteland.com). The giftofwisdom.com website out sources the actual work to a custom imprinter. The rationale underlying such promotional advertising is that potential consumers having read a particularly attractive quote on the website, quoteland.com, will wish to permanently inscribe that quote on an article of manufacture for decor, personal, or giftware purposes. Indeed, quoteland.com's status as a major quote reference increases the likelihood that potential consumers will frequently see the advertisement for custom imprint and engraving services displayed therein.

Unfortunately, this imprinter has no way to efficiently replicate this partnership to other quotation references similar to quoteland.com and no way to extend the display of promotional free content to messaging. If giftofwisdom.com decided to end the partnership with the custom imprinter, the customer imprinter has no promotional content system in place to replicate the partnership with another quota ional reference website. Additionally, the imprinter relies solely on quoteland.com and giftofwisdom.com content as a promotional content service. If this partnership is severed, the imprinter has no means to use quoteland.com/giftofwisdom.com's quotations, because they originate from and are managed by quoteland.com/giftofwisdom.com. This invention creates a method, system, and process to more effectively promote the services of a custom imprinter via a plurality of partnerships, using a novel mix of services, which effectively use networked content. It is a stronger system for the custom imprinter because he gains the means and system of promotion that he can make to a plurality of partners. Also, because he owns the means and system of promotion, he can add services beyond just the single service running on quoteland.com/giftofwisdom.com. This invention creates a system from which powerful information services can deployed, including messaging and referral methods, described below.

### WRITTEN DESCRIPTION OF THE INVENTION

Method and system to increase the effectiveness of custom imprinting/engraving advertising messages by promoting the indication/imprinting of content the affiliate(s) has agreed to show. The advertising message will accompany the said content.

Business Model:

Internet-based custom imprint services, marketed through delivered content in partnership with affiliates who have chosen to display and to users who may have chosen to receive said content based upon selective criteria.

Publishing System

The system will deliver text content such as witticisms, tips, poetry and quips to cascading groups of affiliates and users.

Selling System

The System is a platform for the marketing of imprint and stenciling services through electronic commerce. Network based sales will be generated be generated internally and by a multi-tier network of affiliates on a free and pay-for-performance basis. User subscriptions to series of content will also be generated internally and by a multi-tier network of affiliates on a free and pay-for-performance basis.

Online Systems Technology

The content code will also be accompanied with an invitation inviting the reader to do one or more of the following four actions, all designed to promote and product the sale of custom imprint services:

1) Imprint/etch the viewed content to an item of their choice

2)Subscribe to a free series of promotional content to be delivered at pre-determined intervals

3)Add a similar series of content to their own Informational delivery vehicle to promote said services

4)Refer displayed content to a person or group of people via messaging.

The Four Services are Described Below:

1)Imprint/etch the viewed content to an item of their choice—If the user desires to imprint/engrave the displayed content, they will be receive a response page which will incorporate the said content into an item for sale. The System will facilitate the design, customization, and purchase of the product(s) chosen by the user.

2)Subscribe to a free series of promotional content to be delivered at pre-determined intervals—If the user agrees to subscribe to series of content, the system then continues with the user's selection to receive series of content pertinent to his purposes, needs, interests, and tastes. The content will be sent to the customer via electronic means at predetermined intervals.

After receiving the customer's selection criteria, the software system delivers the series of content and incorporates advertising messages inviting the customer to order items customized with indications/imprints of the content contained in digital message to the customer. A given advertisement message possesses a very high degree of applicability respect to the selection criterion input by the customer because it offers to permanently preserve content the customer that matches that customer's interests and purposes.

Each digital message the user receives contains the content matching their selection criterion and incorporates an invitation to permanently imprint/indicate/etch the said content into a product. The invitation will consist of an advertisement inviting the read to click on a hyperlink, hidden or visible, to receive a response page which will incorporate the said content into a product for sale. The System will facilitate the design, customization, and purchase of the product(s) chosen by the user. The message will also contain sponsorship information linking to the information delivery vehicle.

3)Add a similar series of content to their own Informational delivery vehicle to promote said services—System will be a central controller to deliver text content such as a quotation of the day a multi-tier basis. The first tier are affiliates who sign up with the system and the descending tiers comprise multiple affiliates who signup under the first tier affiliates. Affiliates can be paid a percentage of any sale made through the system. By signing up for an account using the system, a affiliate becomes a first tier affiliate able to promote and remotely deliver that content to visitors of the information delivery vehicles. The second tier affiliate is a sub affiliate of the first tier affiliate. The first tier affiliates makes a percentage of any sale the second tier makes.

The System server delivers the content to both first and second tier affiliates' information delivery vehicles for viewing by visitors or subscribers of the affiliates content. 4)Refer displayed content to a person or group of people via messaging—The Promotional System also has a “Send content to a friend” service which allows the viewer of the content container to easily send the displayed content (i.e. “quote of the day”) to a person(s). The digital message the person(s) receives contains the referred content and incorporates an invitation to permanently imprint/indicate/etch the said content into a product. The invitation will consist of an advertisement inviting the read to click on a hyperlink, hidden or visible, to receive a response page which will incorporate the said content into a product for sale. The System will facilitate the design, customization, and purchase of the product(s) chosen by the user. The message will also contain sponsorship information linking to the information delivery vehicle.

Promotional Content Display Service

Configuration

The first service is a content container, which receives and displays a series of content (i.e. quote of the day) from the central controller. The IDV can now choose to carry a series of content based upon subject and can choose to have said content change on a non-predetermined (random) basis or pre-determined schedule or to have the content static (permanent). This content container itself includes an action container, which includes an invitation to permanently imprint/indicate/etch the said content onto a product. The invitation consists of an advertisement inviting the reader to click on a hyperlink, hidden or visible, and receive a response page, which will incorporate the said content into a product for sale. The action container may also display invitational hyperlinks to the secondary services provisioned on behalf of the IDV and invite the visitor to the IDV to participate in the secondary services, all for the ultimate purpose of purchasing or promoting the (408)purchase of custom imprint services.

Implementation

The IDV operator enters choices for look of the content container and the category of the series of content and central controller builds the content container code. The central controller displays the code to the IDV operator, which the operator of the IDV can “plug” into their IDV and display to visitors. The code includes the affiliate identifier of IDV.

After receiving content container code from the central controller, IDV operator adds the content container code to their IDV. When a person views the information delivery vehicle, they will see the content container, which includes textual content such as a quote of the day. The viewer reads the text (i.e. “quote of the day”) and glances down to the action container where they see an invitation to imprint/engrave/etch said content onto a product of their choice. The viewer then chooses to imprint/engrave said content by using the invitational hyperlink to connect to the central controller's purchasing system. The invitational hyperlink contains the IDV's affiliate ID to track the referral from the IDV.

The Purchasing System facilitates the design, customization, and purchase of the product(s) chosen by the user. User fills out ordering form and chooses customization options, which includes, but is not limited to choosing the item on which said content will be imprinted/engraved/etched. There also may be other customizations such as the color, style and/or design of the text to be imprinted. The user can also whether to make changes to said content or go forward with the content as it was originally viewed. User is next taken to a page where they get the choice to make payment over the phone or the online checkout center.

During the purchase of custom imprint services, the central controller will associate the referral affiliate ID used in invitational hyperlink with the customer using the Purchasing system. If the customer does not complete the purchase process, the affiliate ID will saved in the customer's enabled profile for later visits to the Purchasing System. If the customer has completed the purchase process, the affiliate ID associated with the purchase will credited with percentage based payment for the sale.

Promotional Messaging Service

Configuration

In addition to the Promotional content delivery service, the IDV can sign up to participate in the Promotional Messaging Service. The Promotional Messaging Service allows the IDV's Internet address to be promoted in promotional messages containing the same offer the invitation.

The IDV operator goes to the controller management page and chooses to start the Promotional content delivery service. The central controller goes to a configuration page, which shows the sponsor options for what appears on the top of the Promotional Message.

Implementation

After signing up for the service, the central controller sends the IDV operator an updated content container code including the newly added invitation for an IDV visitor to receive content similar to the Promotional content on a pre-determined schedule.

After receiving new content container code from the central controller, IDV operator adds the content container code to their IDV. When a person views the information delivery vehicle, they will see the content container, which includes textual content such as a quote of the day. The viewer reads the text (i.e. “quote of the day”) and glances down to the action container where they see in addition to text to imprint/engrave/etch said content onto a product of their choice, an invitation for an IDV visitor to receive content similar to the above Promotional content on a pre-determined schedule via electronic messaging.

The viewer is taken to a page where they then choose to subscribe to receive series of content by using the invitational hyperlink to connect to the central controller's messaging subscription system. Visitor chooses to receive a series of content via messaging by entering his name, electronic messaging address, and the frequency of message delivery.

After receiving the customer's selection criteria, the software system delivers the series of content and incorporates advertising messages inviting the customer to order items customized with indications/imprints of the content contained in digital message to the customer. The message also contains sponsorship information including the name of the referring IDV and the Internet address of the referring IDV.

User views a particularly attractive segment of content in a message. User chooses to imprint/engrave segment(s) of the said content by clicking on the advertisement hyperlink included in the message. The invitational hyperlink contains the IDV's affiliate ID to track the referral from the IDV.

The Purchasing System facilitates the design, customization, and purchase of the product(s) chosen by the user. User fills out ordering form and chooses customization options, which includes, but is not limited to choosing the item on which said content will be imprinted/engraved/etched. There are also other customizations such as the color, style and/or design of the text to be imprinted. The user can also decide as to whether to make changes to said content or go forward with the content as it was originally viewed. User is next taken to a page where they get the choice to make payment over the phone or the online checkout center.

During the purchase of custom imprint services, the central controller will associate the referral affiliate ID used in invitational hyperlink with the customer using the Purchasing system. If the customer does not complete the purchase process, the affiliate ID will saved in the customer's enabled cookie profile for later visits to the Purchasing System. If the customer has completed the purchase process, the affiliate ID associated with the purchase will credited with percentage based payment for the sale.

Multi-tier Affiliate Service

Configuration

In addition to the Promotional content delivery service, the IDV can also sign up to participate in the multi-tier affiliate service. The multi-tier affiliate service allows the IDV to make commissions off referrals of other IDVs that have signed up to come an affiliate through the IDV's content container. The IDV operator goes to the controller management page and chooses to start the

Multi-Tier Affiliate Service

Implementation

After signing up for the service, the central controller sends the IDV operator an updated content container code including the newly added invitation for an IDV visitor to add a content container to his or her own IDV.

After receiving new content container code from the central controller, IDV operator adds the content container code to their IDV. When a person views the information delivery vehicle, they will see the content container, which includes textual content such as a quote of the day. The viewer reads the text (i.e. “quote of the day”) and glances down to the action container where they see in addition to text to imprint/engrave/etch said content onto a product of their choice, an invitation for an IDV visitor to add a similar content box to their page and become an affiliate of the custom imprinting/etch/engraving service.

The viewer selects the hyperlink and is taken to a description of the System and a sign-up page. The invitational hyperlink contains the referring IDVs affiliate ID to track the referral from the IDV. The referred IDV can now signup to get a content container, which receives and displays a series of content (i.e. quote of the day) from the central controller just as the referring IDV did. They are a sub-affiliate of the referring IDV and any sales made through their content services generates a commission for the referring IDV.

Recommend Content Service

The Promotional System also has a “Send content to a friend” service, which allows the viewer of the content container to easily send the content (i.e. “quote of the day”) to a friend.

Configuration

The IDV operator goes to the controller management page and chooses to start the “Send content to a friend” service. The central controller goes to a configuration page, which shows the sponsor options for what appears on the top of the Promotional Message sent through the “Recommended Content service.

Implementation

After signing up for the service, the central controller sends the IDV operator an updated content container code including the newly added invitational link to send the displayed content (i.e. “quote of the day”) to a friend.

After receiving new content container code from the central controller, IDV operator adds the content container code to their IDV. When a person views the information delivery vehicle, they will see the content container, which includes textual content such as a quote of the day. The viewer reads the text (i.e. “quote of the day”) and glances down to the action container where they see in addition to text to imprint/engrave/etch said content onto a product of their choice, an invitation for an IDV visitor to send the displayed content (i.e. “quote of the day”) to a friend.

The viewer is taken to a page where they enter the message address of the party(s) to whom they wish to recommend the content (i.e. “quote of the day”).

They click to send the content to a friend. The central controller creates a message from the displayed content (i.e. “quote of the day”) and sends it to the recipients the viewer previously listed. Included with such a message is a link to the referring IDV and an promotional message and link to imprint/engrave/etch said content onto a product of their choice. The promotional message links back to the Purchasing Module of the Promotional System.

If the recipient of the message likes the displayed content, they can chooses to imprint/engrave segment(s) of the said content by clicking on the advertisement hyperlink included in the message. The invitational hyperlink contains the IDV's affiliate ID to track the referral from the IDV.

The Purchasing System facilitates the design, customization, and purchase of the product(s) chosen by the user. User fills out ordering form and chooses customization options, which includes, but is not limited to choosing the item on which said content will be imprinted/engraved/etched. There are also other customizations such as the color, style and/or design of the text to be imprinted. The user can also decide as to whether to make changes to said content or go forward with the content as it was originally viewed. User is next taken to a page where they get the choice to make payment over the phone or the online checkout center.

During the purchase of custom imprint services, the central controller will associate the referral affiliate ID used in invitational hyperlink with the customer using the Purchasing system. If the customer does not complete the purchase process, the affiliate ID will saved in the customer's enabled cookie profile for later visits to the Purchasing System. If the customer has completed the purchase process, the affiliate ID associated with the purchase will credited with percentage based payment for the sale.

### BRIEF DESCRIPTION OF THE DRAWINGS

The foregoing and other objects, aspects, uses, and advantages of the present invention will be more fully appreciated as the same becomes better understood when considered in connection with the following a invention drawings, in which:

FIG. 1—Shows an overview of system with a plurality of services and a plurality of affiliates

FIG. 2—Shows the Sign-Up Process for the Information Delivery Vehicle

FIG. 3—Shows an overview of Services offered by the System's central controller

FIG. 4—Shows an overview of the promotional content display service and the content container

FIG. 5—Shows the Promotional content display service sign-up process

FIG. 6—Shows the implementation of the promotional content display service

FIG. 7—Shows system central controller Customization and Purchase process

FIG. 8—Shows the process of paying Information Delivery Vehicle for purchase

FIG. 9—Shows the Promotional Messaging service configuration and implementation

FIG. 10—Shows the Promotional Messaging service delivery and marketing process

FIG. 11—Shows the system central controller Customization and Purchase process

FIG. 12—Shows the process of paying Information Delivery Vehicle for purchase

FIG. 13—Shows the implementation of the Multi-tier affiliate process

FIG. 14—Shows the implementation of the Recommend Content service

FIG. 15—Shows the Recommend Content service delivery and marketing process

FIG. 16—Shows the system central controller Customization and Purchase process

FIG. 17—Shows the process of paying Information Delivery Vehicle for purchase

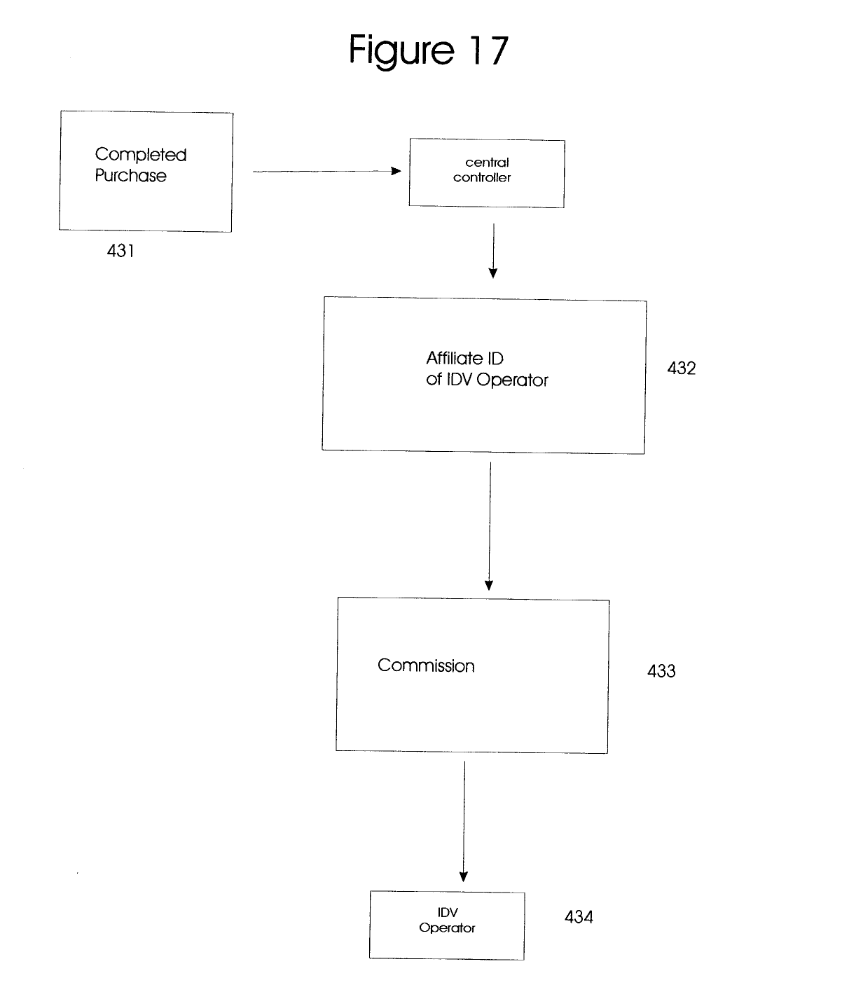

### DETAIL DESCRIPTION OF DRAWINGS

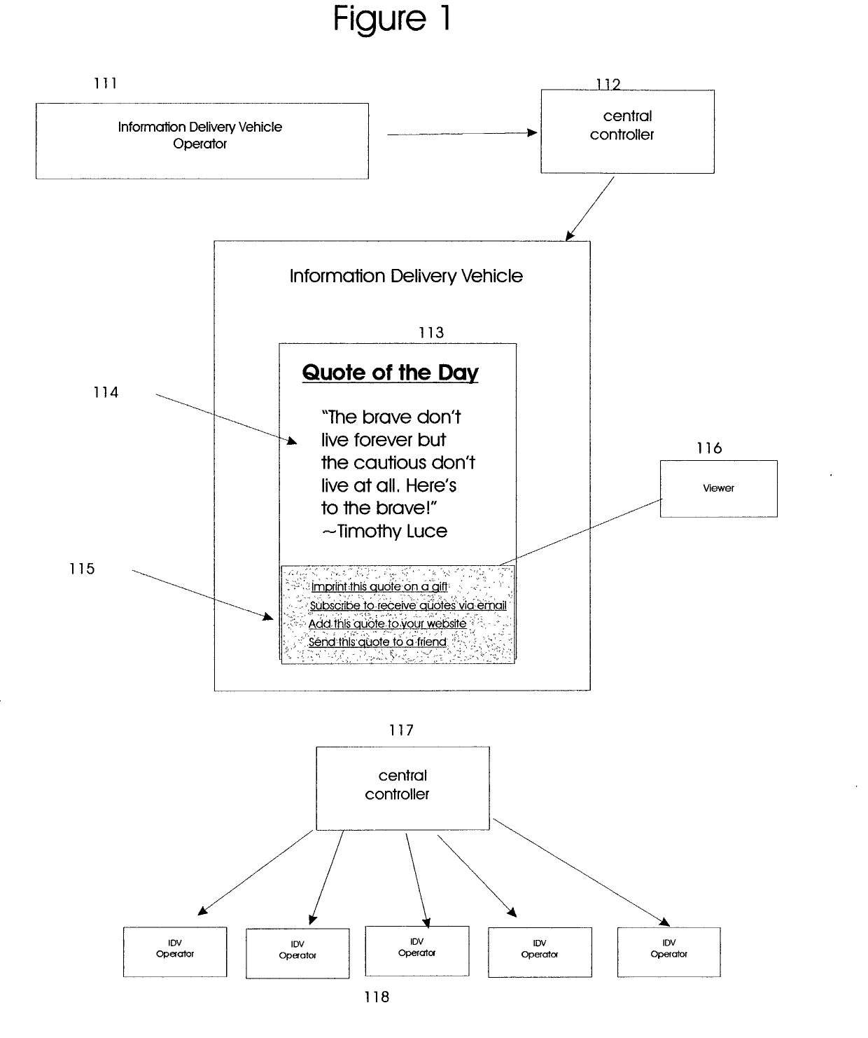

FIG. 1 is a diagram showing the (111)operator of an information delivery vehicle (IDV) visits the networked site of the (112)central controller to sign-up to display a (113)container including (114)series of content and (115)custom imprint promotional services from the central controller system. This series of content is textual in nature and changes either randomly or on a pre-determined schedule. By signing up to carry said series of content, the information delivery vehicle becomes a paid or non-paid affiliate, that is, they do not pay to join or get paid on the traditional “cost per mille” or CPM model. Any compensation paid to the information delivery vehicle is based on their ability to refer (116)viewers of the networked content to purchase custom imprint services and products. The (117)Central controller can (118)replicate this partnership with any number of (119)IDVs.

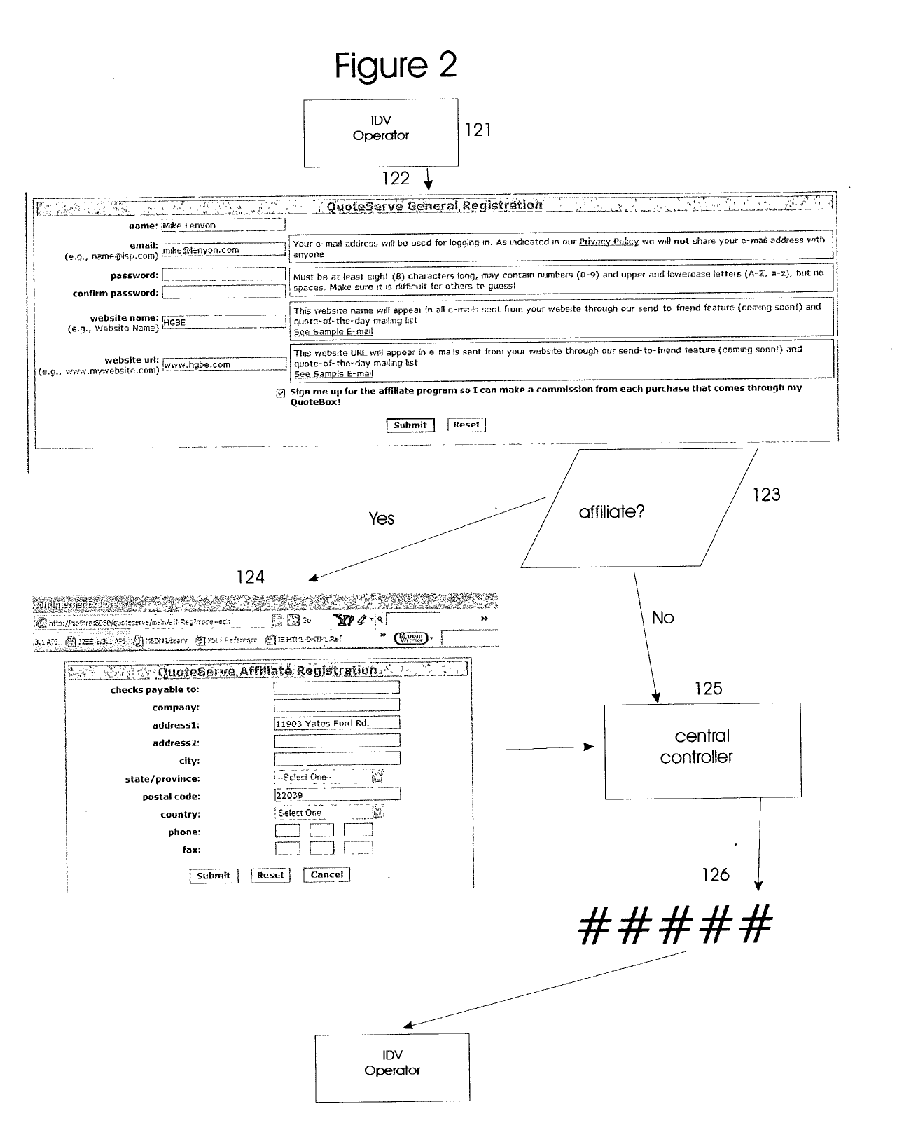

FIG. 2 is a diagram showing the (121)IDV operator enters their (122)personal and/or organizational information, including, but not limited to their name, physical address, networked messaging address, and the Internet address of their information delivery vehicle. The IDV may have the (123)opportunity to choose to become a performanced based(124) affiliate of the customer imprinter. The IDV submits the signup form to the (125)central controller and is accepted as a carrier of content, and if they chosen to be so, an affiliate of the custom imprinter. The central controller creates an (126)alphanumeric identifier, which will accompany any referral to purchase custom imprint services.

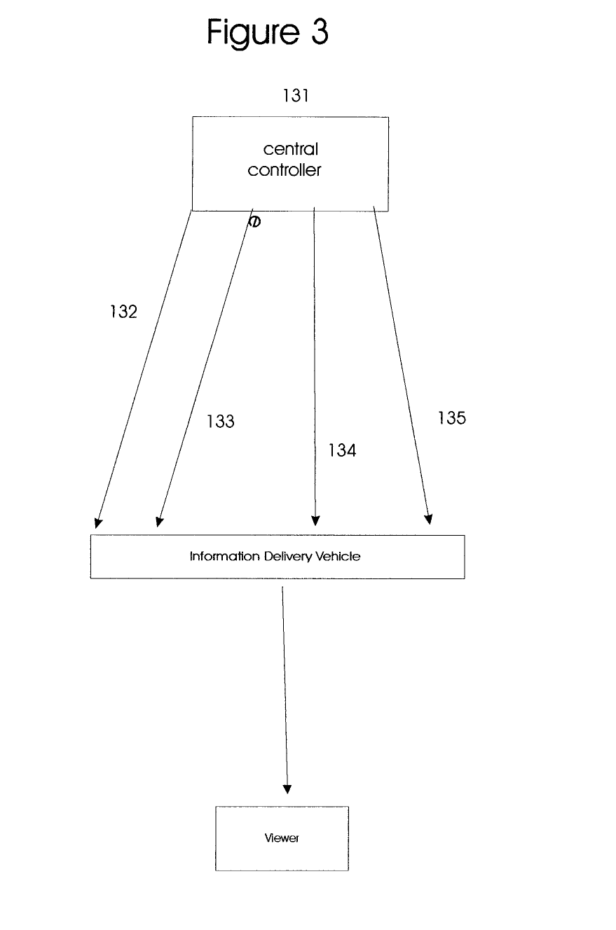

FIG. 3 is a diagram showing that upon the sign-up of the IDV, the (131)central controller provisions one or more promotional services for the IDV: (132)Promotional content display service (primary) (133)messaging promotional service (secondary) (134)multi-tier affiliate service (secondary) (135)“send content to a friend” service (secondary) The first service (132)is primary. The last three are secondary services, which may be added to the first in any combination. All four are for the purpose of selling custom imprint services

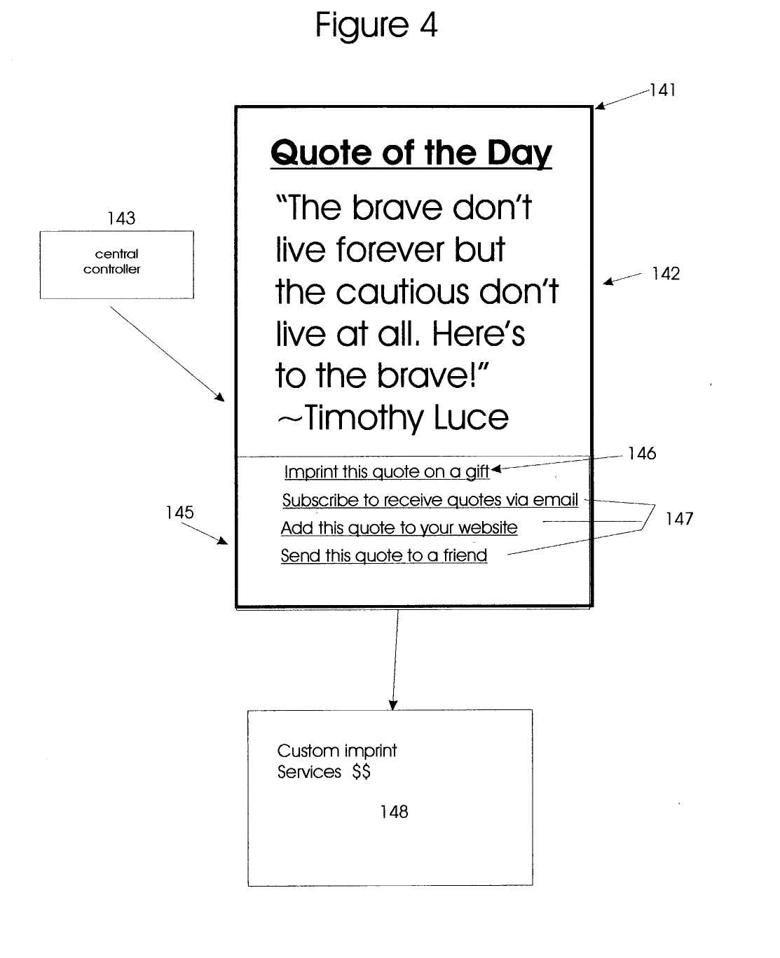

FIG. 4 is a diagram showing the first service is a (141)content container, which receives and displays a (142)series of content (i.e. quote of the day) from the (143)central controller. The IDV can now choose to carry a series of content based upon subject and can choose to have said content change on a non-predetermined (random) basis or predetermined schedule or to have the content static (permanent). This content container itself includes an (145)action container, which includes an (146)invitation to permanently imprint/indicate/etch the said content onto a product. The invitation consists of an advertisement inviting the reader to click on a hyperlink, hidden or visible, and receive a response page, which will incorporate the said content into a product for sale. The action container may also display invitational hyperlinks to the (147)secondary services provisioned on behalf of the IDV and invite the visitor to the IDV to participate in the secondary services, all for the ultimate purpose of purchasing or promoting the (148)purchase of custom imprint services.

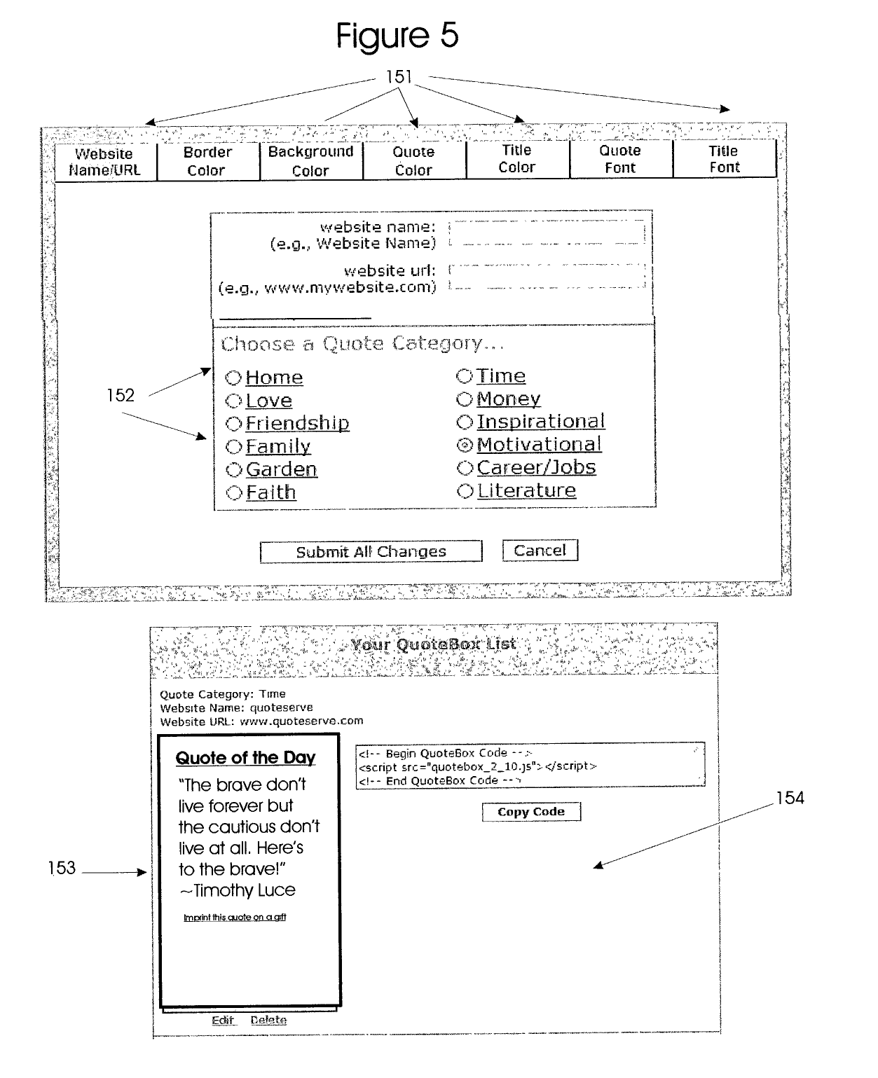

FIG. 5 is a diagram showing the IDV operator enters choices for (151)look of the content container and the (152)category of the series of content and central controller builds the (153)content container code. The central controller (154)displays the code to the IDV operator, which the operator of the IDV can “plug” into their IDV and display to visitors. The code includes the affiliate identifier of IDV.

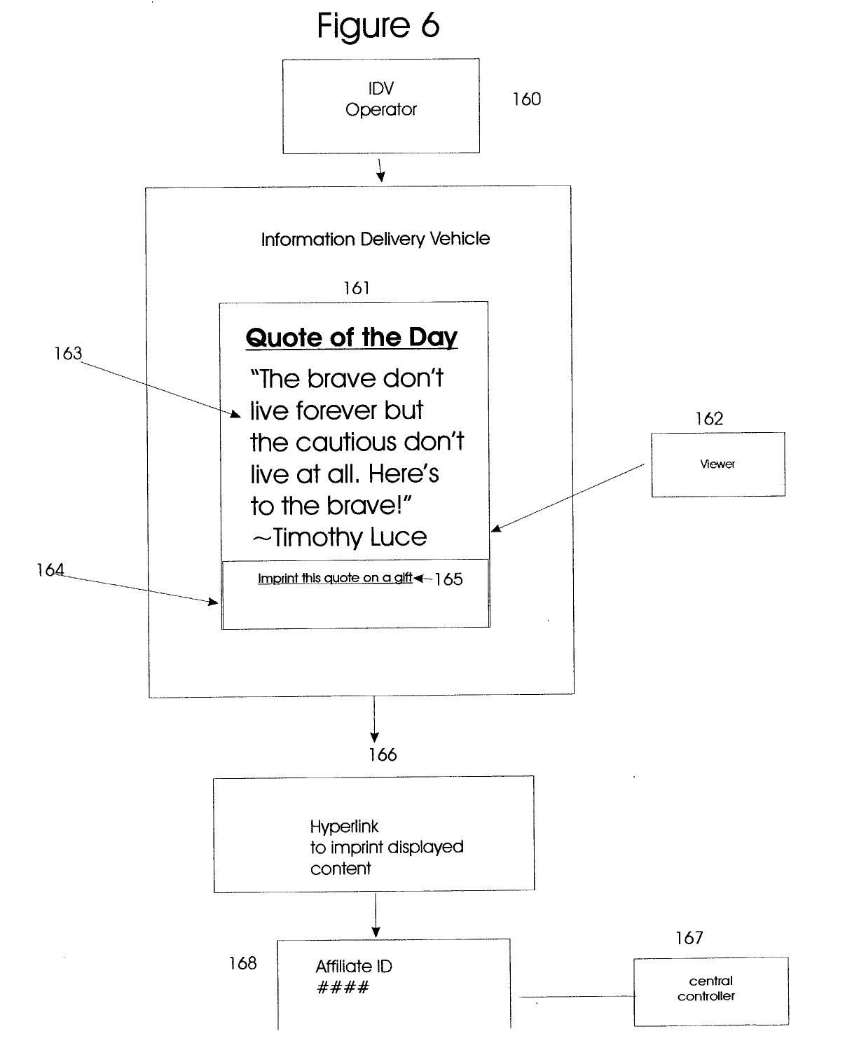

FIG. 6 is a diagram showing that after receiving content container code from the central controller, (160)IDV operator adds the content container code to their IDV. When a person views the information delivery vehicle, they will (162)see the (161)content container, which includes (163)textual content such as a quote of the day. The viewer reads the text (i.e. “quote of the day”) and glances down to the (164)action container where they see an (165)invitation to imprint/engrave/etch said content onto a product of their choice. The (166)viewer then chooses to imprint/engrave said content by using the invitational hyperlink to connect to the (167)central controller's purchasing system. The invitational hyperlink contains the IDV's (168)affiliate ID to track the referral from the IDV.

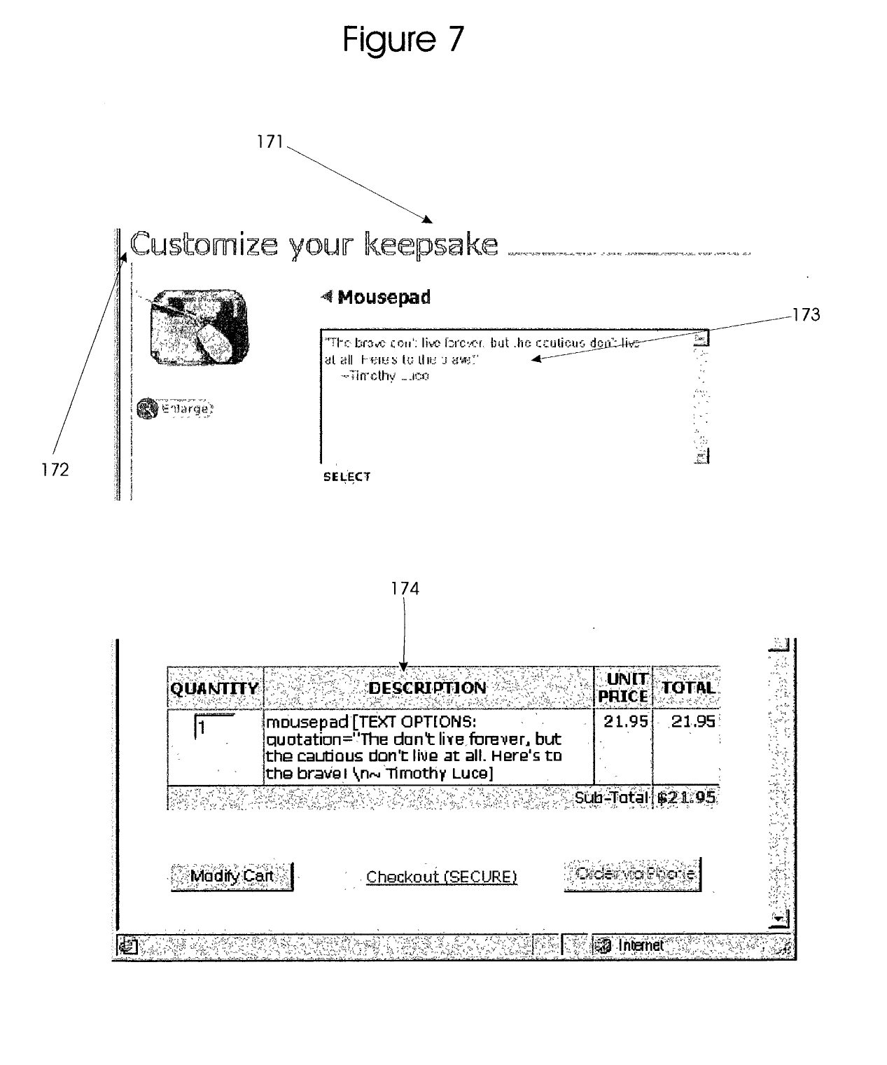

FIG. 7 is a diagram showing the Purchasing System facilitates the design, customization, and purchase of the product(s) chosen by the user. User fills out (171)ordering form and chooses (172)customization options, which includes, but is not limited to choosing the item on which said content will be imprinted/engraved/etched. There also may be other customizations such as the color, style and/or design of the text to be imprinted. (173)The user can also whether to make changes to said content or go forward with the content as it was originally viewed. User is next taken to a (174)page where they get the choice to make payment over the phone or the online check-out center.

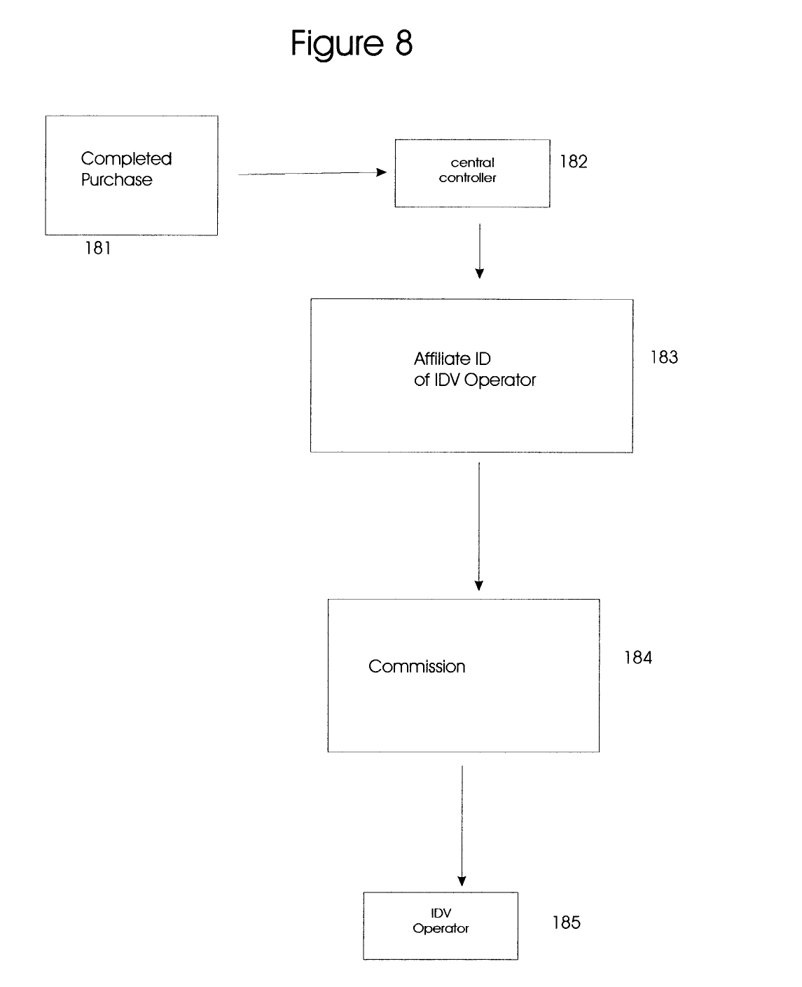

FIG. 8 is a diagram showing that during the (181)purchase of custom imprint services, the (182)central controller will associate the referral affiliate ID used in invitational hyperlink with the customer using the Purchasing system. If the customer does not complete the purchase process, the affiliate ID will saved in the customer's enabled profile for later visits to the Purchasing System. If the customer has completed the purchase process, the (183)affiliate ID associated with the purchase will (184)credited with percentage based payment for the sale and will flow through to the IDV(185).

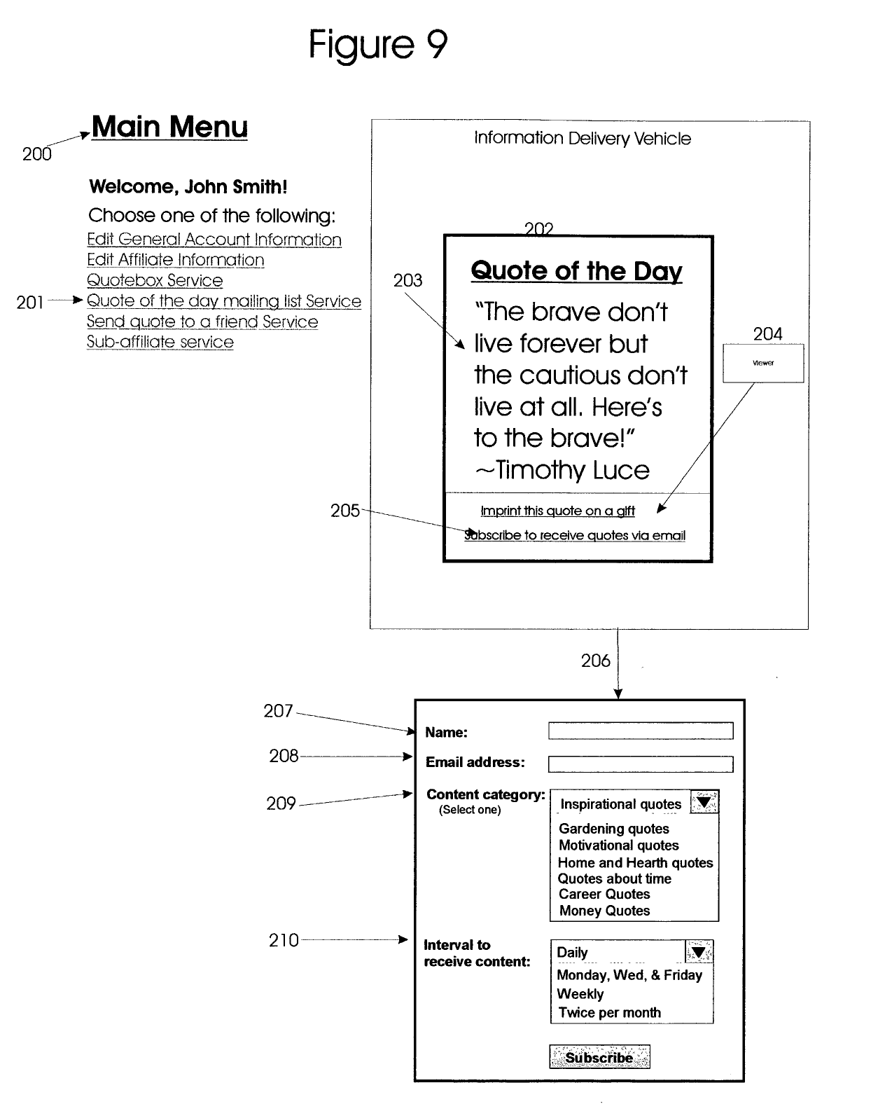

FIG. 9 is a diagram showing that in addition to the Promotional content delivery service, the IDV can sign up to participate in the Promotional Messaging Service. The IDV operator goes to the (200)controller management page and chooses to start the (201)Promotional content delivery service. The central controller goes to a configuration page, which shows the sponsor options for what appears on the top of the Promotional Message. After signing up for the service, the central controller sends the IDV operator an updated content container code including the newly added invitation for an IDV visitor to receive content similar to the Promotional content on a pre-determined schedule. After receiving new content container code from the central controller, IDV operator adds the (202)content container code to their IDV. When a person views the information delivery vehicle, they will see the content container, which includes (203)textual content such as a quote of the day. The (204)viewer reads the text (i.e. “quote of the day”) and glances down to the action container where they see in addition to text to imprint/engrave/etch said content onto a product of their choice, an (205)invitation for an IDV visitor to receive content similar to the above Promotional content on a predetermined schedule via electronic messaging. The viewer is taken to a page where they then (206)choose to subscribe to receive series of content by using the invitational hyperlink to connect to the central controller's messaging subscription system. Visitor chooses to receive a series of content via messaging by (207)entering his name, (208)electronic messaging address, (209)type of content, and the (210)frequency of message delivery.

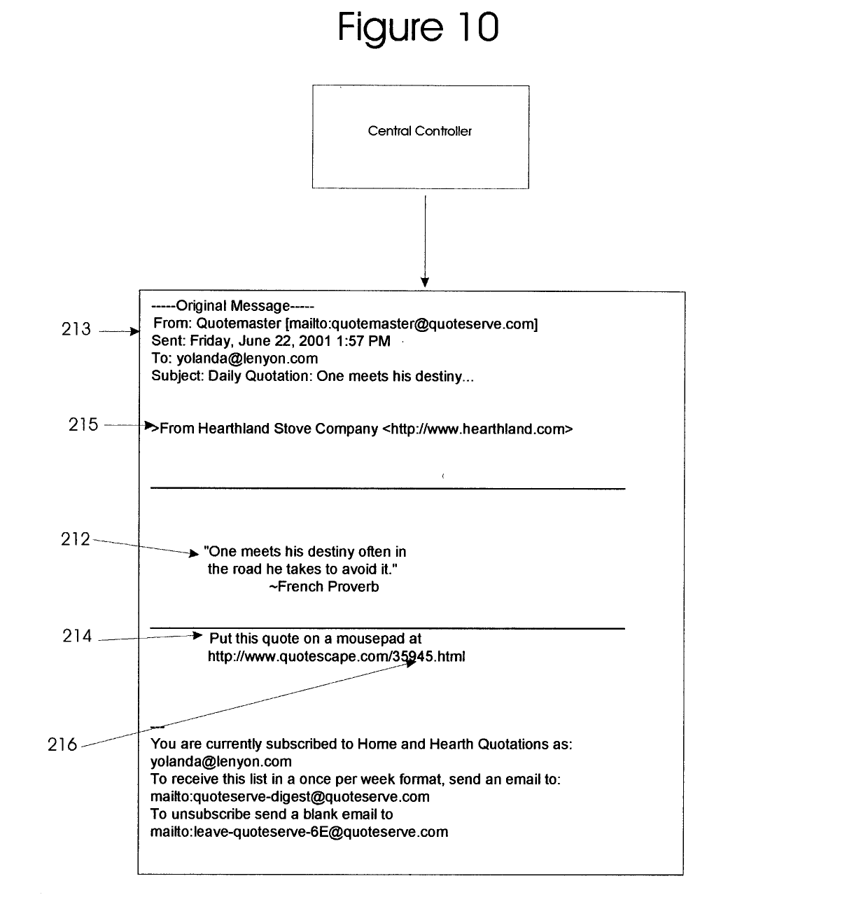

FIG. 10 is a diagram showing that after receiving the customer's selection criteria, the (211)central controller software system delivers the (212)series of content (i.e. “quote of the day”)via (213)electronic messages and incorporates (214)advertising messages inviting the customer to order items customized with indications/imprints of the content contained in digital message to the customer. The message also contains (215)sponsorship information including the name of the referring IDV and the Internet address of the referring IDV. User views particularly attractive content in a message. User chooses to imprint/engrave segment(s) of the said content by clicking on the (214)advertisement hyperlink included in the message. The invitational hyperlink contains the IDV's (216)affiliate ID to track the referral from the IDV.

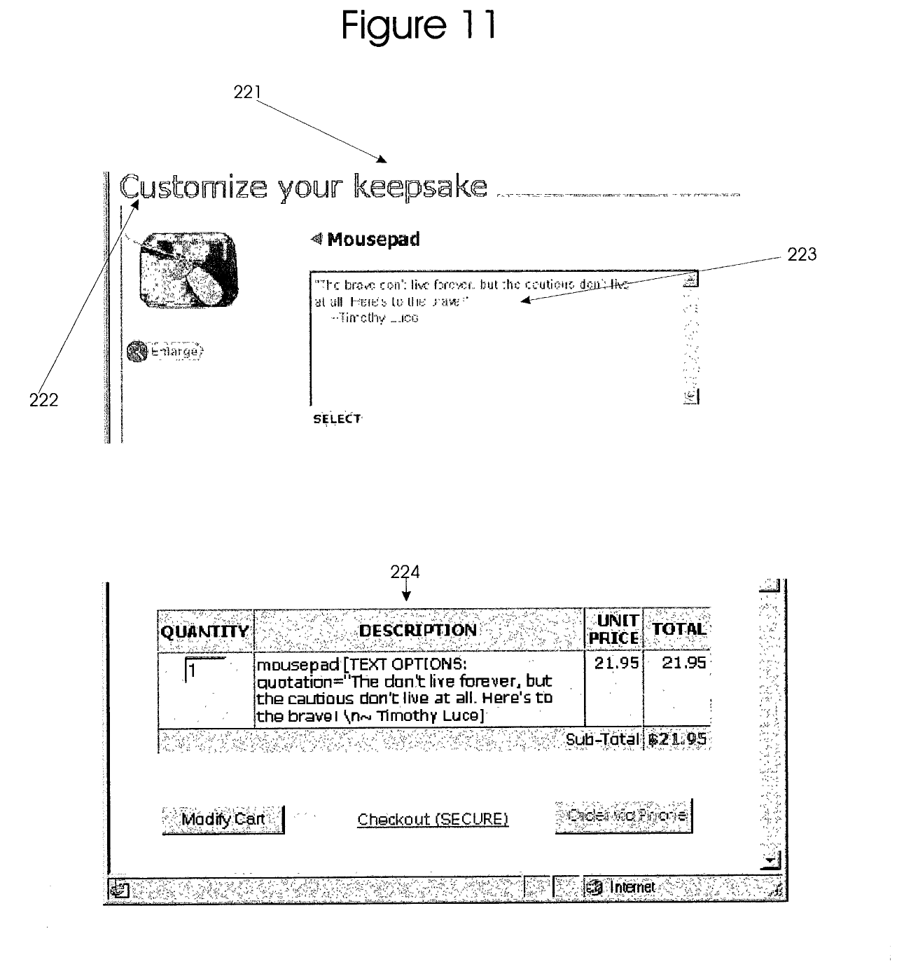

FIG. 11 is a diagram showing the Purchasing System facilitates the design, customization, and purchase of the product(s) chosen by the user. User fills out (221)ordering form and chooses (222)customization options, which includes, but is not limited to choosing the item on which said content will be imprinted/engraved/etched. There also may be other customizations such as the color, style and/or design of the text to be imprinted. (223)The user can also whether to make hangers to said content or go forward with the content as it was originally viewed. User is next taken to a (224)page where they get the choice to make payment over the phone or the online check-out center.

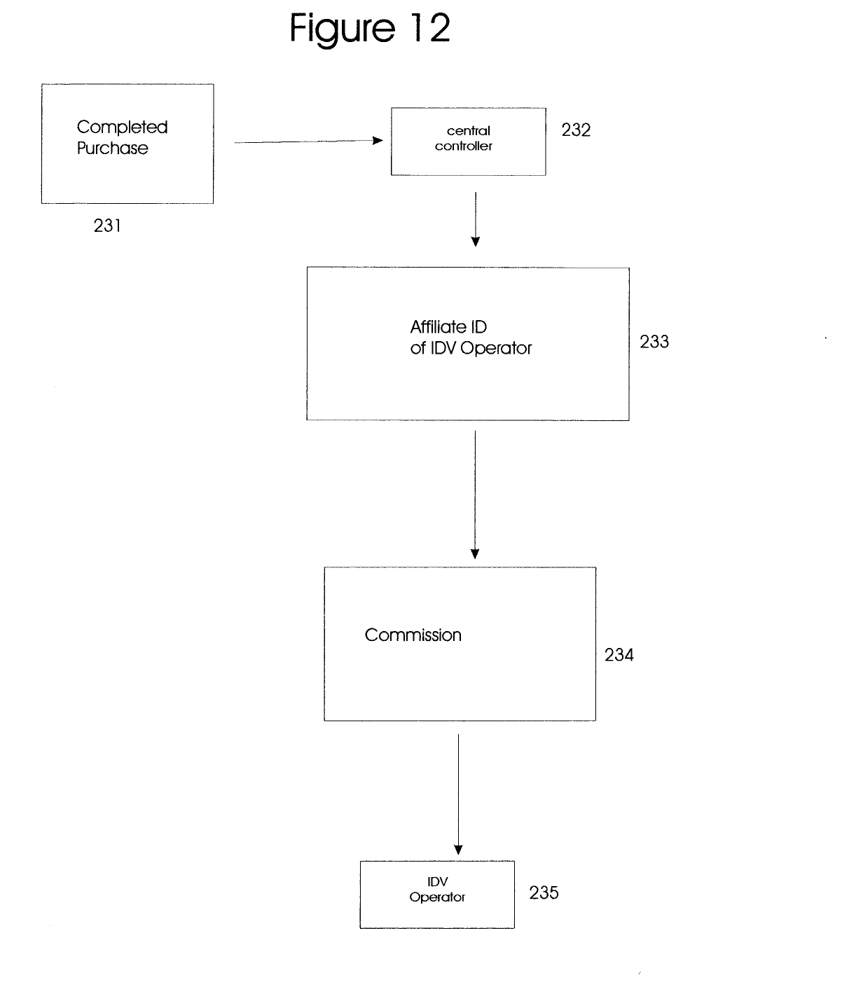

FIG. 12 a diagram showing During the (231)purchase of custom imprint services, the (232)central controller will associate the referral affiliate ID used in invitational hyperlink with the customer using the Purchasing system. If the customer does not complete the purchase process, the affiliate ID will saved in the customer's enabled profile for later visits to the Purchasing System. If the customer has (233)completed the purchase process, the (234)affiliate ID associated with the purchase will (235)credited with percentage based payment for the sale.

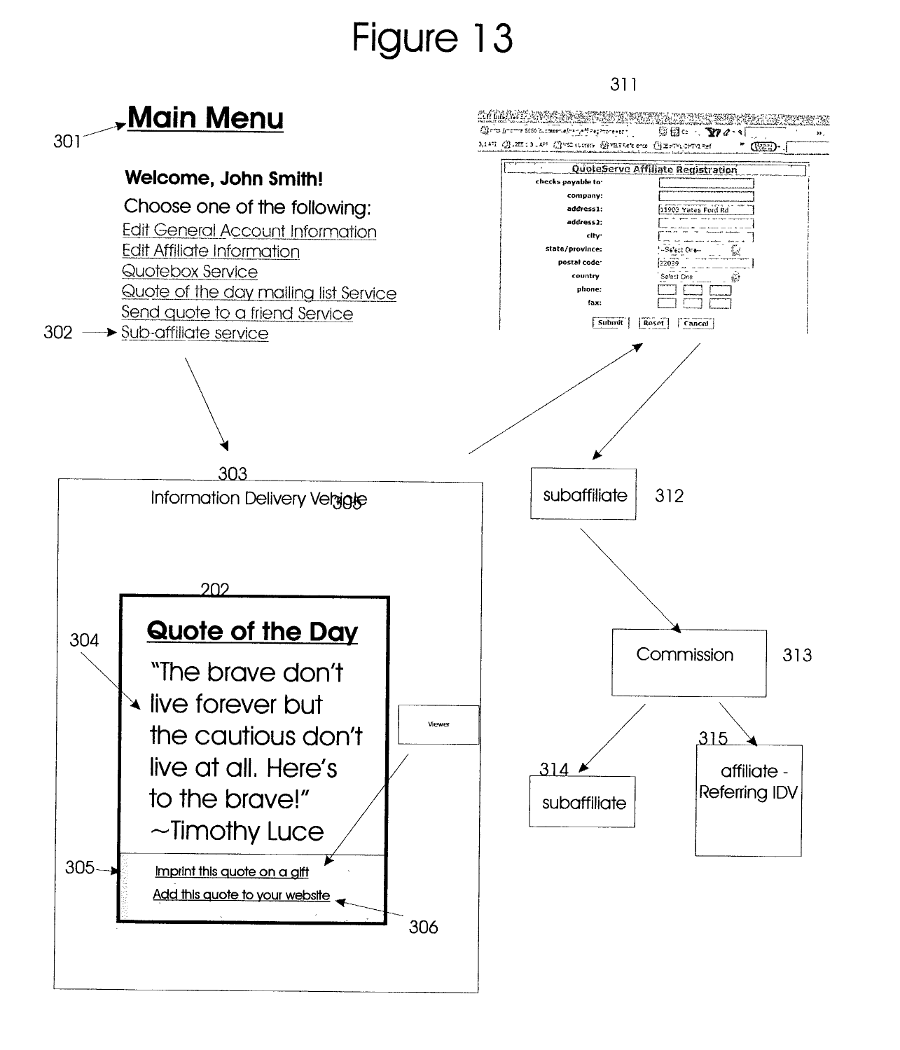

FIG. 13 a diagram showing In addition to the Promotional content delivery service, the IDV can also sign up to participate in the multi-tier affiliate service. The multi-tier affiliate service allows the IDV to make commissions off referrals of other IDVs that have signed up to come an affiliate through the IDV's content container. The IDV operator goes to the (301)controller management page and chooses to start the (302)Multi-tier affiliate service. After signing up for the service, the central controller sends the IDV operator an updated content container code including the newly added invitation for an IDV visitor to add a content container to their own IDV. After receiving new content container code from the central controller, IDV operator adds the content container code to their IDV. When a person views the (303)information delivery vehicle, they will see the content container, which includes (304)textual content such as a quote of the day. The viewer reads the text (i.e. “quote of the day”) and glances down to the (305)action container where they see in addition to text to imprint/engrave/etch said content onto a product of their choice, an (306)invitation for an IDV visitor to add a similar content box to their page and become an affiliate of the custom imprinting/etch/engraving service. The viewer selects the hyperlink and is taken to a description of the System and a sign-up page. The invitational hyperlink contains the referring IDV's affiliate ID to track the referral from the IDV. The referred IDV can now (311)signup to get a content container, which receives and displays a series of content (i.e. quote of the day) from the central controller just as the referring IDV did. They are a (312)sub-affiliate of the referring IDV and any custom imprint sales made through their content services generates a (313)commission for the (314)referring IDV, as well for the (315)sub-affiliate.

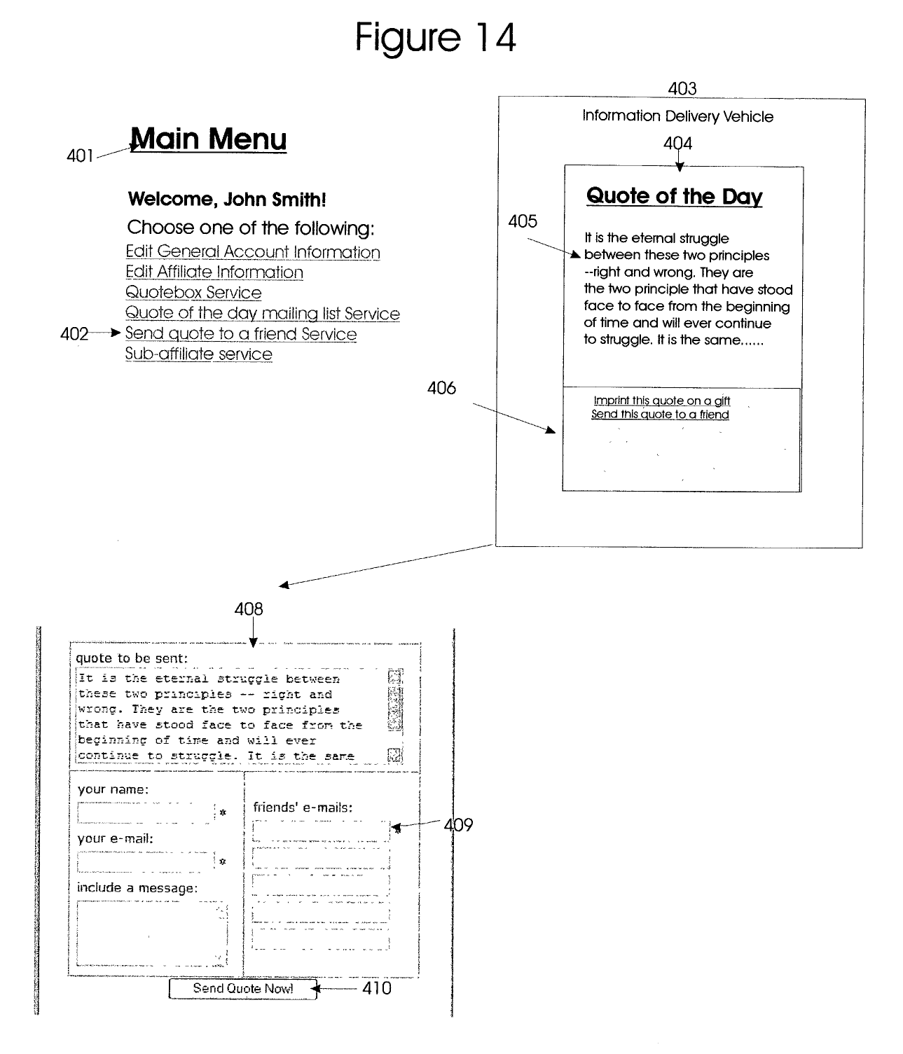

FIG. 14 is a diagram showing The Promotional System also has a “Send content to a friend” service, which allows the viewer of the content container to easily send the content (i.e. “quote of the day”) to a friend. The IDV operator goes to the (401)controller management page and chooses to start the (402)“Send content to a friend” service. The central controller goes to a configuration page, which shows the sponsor options for what appears on the top of the Promotional Message sent through the “Recommended Content service. After signing up for the service, the central controller sends the IDV operator an updated content container code including the newly added invitational link to send the displayed content (i.e. “quote of the day”) to a friend. After receiving new content container code from the central controller, IDV operator adds the content container code to their IDV. When a person views the (403)information delivery vehicle, they will see the (404)content container, which includes (405)textual content such as a quote of the day. The viewer reads the text (i.e. “quote of the day”) and glances down to the (406)action container where they see in addition to text to imprint/engrave/etch said content onto a product of their choice, an (407)invitation for an IDV visitor to send the (405)displayed content (i.e. “quote of the day”) to a friend. The viewer is taken to a (408)page where they enter the (409)messaging address of the party(s) to whom they wish to recommend the content (i.e. “quote of the day”). They (410)click to send the content to a friend.

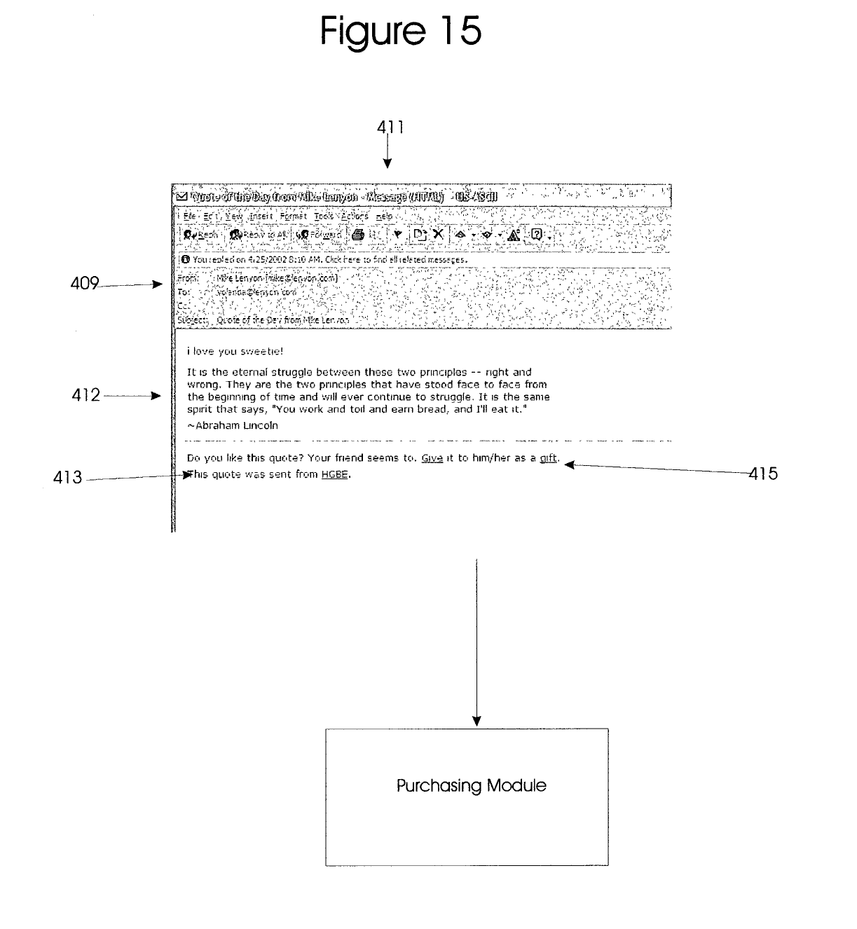

FIG. 15 is a diagram showing the central controller creates a (411)message from the (412)displayed content (i.e. “quote of the day”) and sends it to the (409)recipients the viewer previously listed. Included with such a message is a (413)link to the referring IDV and an (414)promotional message and (415)link to imprint/engrave/etch said content onto a product of their choice. If the recipient of the message likes the displayed content, they can chooses to imprint/engrave segment(s) of the said content by clicking on the (415)advertisement hyperlink included in the message. The invitational hyperlink contains the IDV's affiliate ID to track the referral from the IDV and links back to the (414)Purchasing Module of the Promotional System.

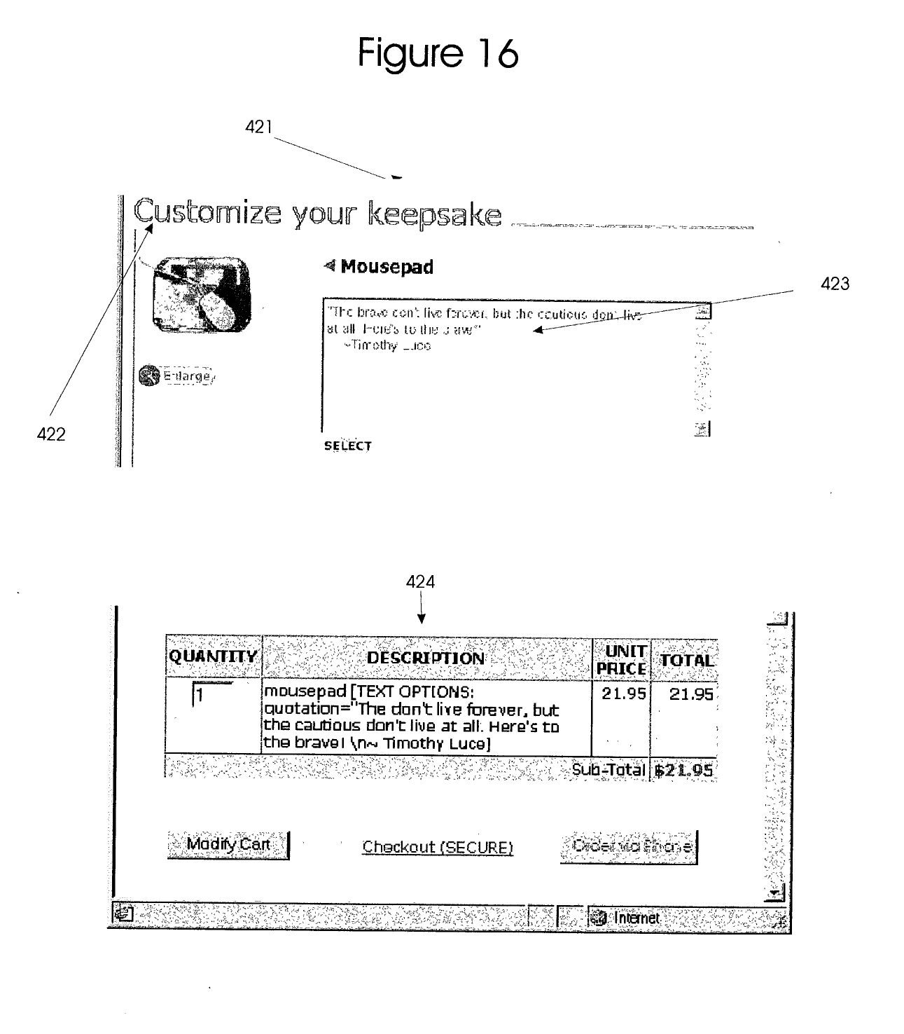

FIG. 16 is a diagram showing The Purchasing System facilitates the design, customization, and purchase of the product(s) chosen by the user. User fills out (421)ordering form and chooses (422)customization options, which includes, but is not limited to choosing the item on which said content will be imprinted/engraved/etched. There also may be other customizations such as the color, style and/or design of the text to be imprinted. (423)The user can also whether to make changes to said content or go forward with the content as it was originally viewed. User is next taken to a (424)page where they get the choice to make payment over the phone or the online check-out center. During the purchase of custom imprint services, the central controller will associate the referral affiliate ID used in invitational hyperlink with the customer using the Purchasing system. If the customer does not complete the purchase process, the affiliate ID will saved in the customer's enabled profile for later visits to the Purchasing System. If the customer has (431)completed the purchase process, the (432)affiliate ID associated with the purchase will be(433)credited with percentage based payment for the sale. This affiliate ID is linked with the (434)IDV's account.

We claim:

1. A method of promotion of custom imprinting services comprising:
a method for a promotional content delivery service wherein, a plurality of individuals, use content containers which receives and displays a series of content (i.e. quote of the day) from the central controller, choose to carry a series of content based upon subject and can choose to have said content change on a non-predetermined (random) basis or pre-determined schedule or to have the content static (permanent);
a method for a promotional messaging service wherein, a plurality of individuals can sign up to participate in the Promotional Messaging Service, can allow the IDV's internet address to be promoted in promotional messages containing the same offer the invitation, can go to the controller management page and chooses to start the Promotional content delivery service, can go to a configuration page which shows the sponsor options for what appears on the top of the Promotional message;
a method for a multi-tiered affiliate service wherein, a plurality of individuals can also sign up to participate in the multi-tier affiliate service, to make commissions off referrals of other IDVs that have signed up to come an affiliate through the IDV's content container, and can go to the controller management page and chooses to start the Multi-tier affiliate service;
a method for a recommended content service wherein, a plurality of individuals have a “Send content to a friend” service which allows the viewer of the content container to easily send the content (i.e. “quote of the day”) to a friend.

2. Apparatus for promotion of custom imprinting services comprising: hardware and devices for promotional content delivery service wherein, a plurality of individuals use content containers which receives and displays a series of content (i.e. quote of the day) from the central controller, choose to carry a series of content based upon subject and can choose to have said content change on a non-predetermined (random) basis or pre-determined schedule or to have the content static (permanent),
hardware and devices for promotional messaging service wherein, a plurality of individuals can sign up to participate in the Promotional Messaging Service, can allow the IDV's internet address to be promoted in promotional messages containing the same offer the invitation, can go to the controller management page and chooses to start the Promotional content delivery service, can go to a configuration page which shows the sponsor options for what appears on the top of the Promotional message;
hardware and devices for multi-tiered affiliate service wherein, a plurality of individuals can also sign up to participate in the multi-tier affiliate service, to make commissions off referrals of other IDVs that have signed up to come an affiliate through the IDV's content container, and can go to the controller management page and chooses to start the Multi-tier affiliate service;
hardware and devices for recommended content service wherein, a plurality of individuals have a “Send content to a friend” service which allows the viewer of the content container to easily send the content (i.e. “quote of the day”) to a friend.

3. A process for promotion of custom imprinting services comprising:
software for promotional content delivery service wherein, a plurality of individuals use content containers which receives and displays a series of content (i.e. quote of the day) from the central controller, choose to carry a series of content based upon subject and can choose to have said content change on a non-predetermined (random) basis or predetermined schedule or to have the content static (permanent);
software for promotional messaging service wherein, a plurality of individuals can sign up to participate in the Promotional Messaging Service, can allow the IDV's internet address to be promoted in promotional messages containing the same offer the invitation, can go to the controller management page and chooses to start the Promotional content delivery service, can go to a configuration page which shows the sponsor options for what appears on the top of the Promotional message;
software for multi-tiered affiliate service wherein, a plurality of individuals can also sign up to participate in the multi-tier affiliate service, to make commissions off referrals of other IDVs that have signed up to come an affiliate through the IDV's content container, and can go to the controller management page and chooses to start the Multi-tier affiliate service;
software for recommended content service wherein, a plurality of individuals have a “Send content to a friend” service which allows the viewer of the content container to easily send the content (i.e. “quote of the day”) to a friend.

4. The invention in accordance with claim 1, wherein a method includes an action container which includes an invitation to permanently imprint/indicate/etch the said content onto a product;
said invitation consists of an advertisement inviting the reader to click on a hyperlink, hidden or visible, and receive a response page which will incorporate the said content into a product for sale;
said action container may also display invitational hyperlinks to the secondary services provisioned on behalf of the IDV and invite the visitor to the IDV to participate in the secondary services, all for the ultimate purpose of purchasing or promoting the purchase of custom imprint services.

5. The invention in accordance with claim 2 wherein the apparatus includes an action container hardware and device means which includes an invitation to permanently imprint/indicate/etch the said content onto a product;
said invitation consists of an advertisement inviting the reader to click on a hyperlink, hidden or visible, and receive a response page which will incorporate the said content into a product for sale;
said action container hardware and device may also display invitational hyperlinks to the secondary services provisioned on behalf of the IDV and invite the visitor to the IDV to participate in the secondary services, all for the ultimate purpose of purchasing or promoting the purchase of custom imprint services.

6. The invention in accordance with claim 3 wherein the software includes an action container software means for an invitation to permanently imprint/indicate/etch the said content onto a product;
said invitation software means consists of an advertisement inviting the reader to click on a hyperlink, hidden or visible, and receive a response page which will incorporate the said content into a product for sale;
said action container software means may also display invitational hyperlinks to the secondary services provisioned on behalf of the IDV and invite the visitor to the IDV to participate in the secondary services, all for the ultimate purpose of purchasing or promoting the purchase of custom imprint services.

7. The invention in accordance with claim 1 wherein the method for an operator of an information delivery vehicle (IDV) to communicate with a networked site is by way of a computer.

8. The invention in accordance with claim 1 wherein the method of the central controller to sign-up to display a container means including series of content means

9. The invention in accordance with claim 1 wherein the method of signing up to carry said series of content; means for custom imprint promotional services from the central controller system;

10. The invention in accordance with claim 1 wherein the method of conveying the information delivery vehicle becomes a paid or non-paid affiliate.

11. The invention in accordance with claim 1 wherein the compensation paid to the information delivery vehicle is based on their ability to refer viewers of the networked content to purchase custom imprint services and products.

12. The invention in accordance with claim 3 wherein the software of the central controller can replicate this partnership with any number of IDVs.

13. The invention in accordance with claim 3 wherein the IDV operator enters their personal and/or organizational information, including, but not limited to their name, physical address, networked messaging address, and the internet address of their information delivery vehicle.

14. The invention in accordance with claim 3 wherein the IDV may have the opportunity to choose to become a performanced based affiliate of the customer imprinter; and the IDV submits the signup form to the central controller and is accepted as a carrier of content, and if they chosen to be so, an affiliate of the custom imprinter.

15. The invention in accordance with claim 3 wherein the software of the central controller creates an alphanumeric identifier, which will accompany any referral to purchase custom, imprint services.

16. The invention in accordance with claim 2 wherein the hardware is a content container, which receives and displays a series of content (i.e. quote of the day) from the central controller.

17. The invention in accordance with claim 3 wherein the IDV can choose to carry a series of content based upon subject matter and can choose to have said content change on a non-predetermined (random) basis or pre-determined schedule or to have the content static (permanent).

18. The invention in accordance with claim 2 wherein the content container includes an action container, which includes an invitation to permanently imprint/indicate/etch, the said content onto a product.

19. The invention in accordance with claim 3 wherein the invitation consists of an advertisement inviting the reader to click on a hyperlink, hidden or visible, and receive a response page which will incorporate the said content into a product for sale.

20. The invention in accordance with claim 3 wherein the action container may also display invitational hyperlinks to the secondary services provisioned on behalf of the IDV and invite the visitor to the IDV to participate in the secondary services, all for the ultimate purpose of purchasing or promoting the purchase of custom imprint services.
